(19) United States
(12) Patent Application Publication
(10) Pub. No.: US 2015/0048943 A1
(43) Pub. Date: Feb. 19, 2015

(54) Anti-loss Systems and Methods for Mobile Devices

(71) Applicant: Marvell World Trade Ltd., St. Michael (BB)

(72) Inventors: Xinhao Chen, Shanghai (CN); Jialin Chen, Shanghai (CN); Wenzhao Fang, Shanghai (CN); Jack Zhu, Shanghai (CN); Jingjing Tan, Shanghai (CN)

(21) Appl. No.: 14/457,654

(22) Filed: Aug. 12, 2014

Related U.S. Application Data
(60) Provisional application No. 61/865,717, filed on Aug. 14, 2013.

(51) Int. Cl. G08B 21/24

(52) U.S. Cl. CPC G08B 21/24
USPC 340/539.32

(57) ABSTRACT

Systems and methods are provided for loss prevention of mobile devices. An anti-loss system for a mobile device includes: a communication module, a services module, and an alarm module. The communication module is configured to establish a connection between a mobile device and an anti-loss device. The services module is configured to: detect a distance between the mobile device and the anti-loss device based at least in part on the connection; in response to the distance between the mobile device and the anti-loss device being larger than a threshold, determine whether the mobile device is lost based at least in part on a user input; and in response to the user input not satisfying one or more conditions, trigger an anti-loss mode. The alarm module is configured to provide an alarm upon the triggering of the anti-loss mode.

### CROSS-REFERENCE TO RELATED APPLICATIONS

This disclosure claims priority to and benefit from U.S. Provisional Patent Application No. 61/865,717, filed on Aug. 14, 2013, the entirety of which is incorporated herein by reference.

### FIELD

The technology described in this patent document relates generally to mobile devices and more particularly to anti-loss equipment for mobile devices.

### BACKGROUND

Mobile devices (e.g., smart phones or tablet computers) play an increasingly important role in everyday life. Mobile devices are often cordless, small and easy to be misplaced or stolen. Once a mobile device is lost, it is usually hard to locate and the owner of the mobile device may suffer economic loss and information loss.

### SUMMARY

In accordance with the teachings described herein, systems and methods are provided for loss prevention of mobile devices. An anti-loss system for a mobile device includes: a communication module, a services module, and an alarm module. The communication module is configured to establish a connection between a mobile device and an anti-loss device. The services module is configured to: detect a distance between the mobile device and the anti-loss device based at least in part on the connection; in response to the distance between the mobile device and the anti-loss device being larger than a threshold, determine whether the mobile device is lost based at least in part on a user input; and in response to the user input not satisfying one or more conditions, trigger an anti-loss mode. The alarm module is configured to provide an alarm upon the triggering of the anti-loss mode.

In one embodiment, an anti-loss method is provided for a mobile device. A connection between a mobile device and an anti-loss device is established. A distance between the mobile device and the anti-loss device is detected based at least in part on the connection. In response to the distance between the mobile device and the anti-loss device being larger than a threshold, whether the mobile device is lost is determined based at least in part on a user input. In response to the user input not satisfying one or more conditions, an anti-loss mode is triggered. An alarm is provided upon the triggering of the anti-loss mode.

In another embodiment, an anti-loss system for mobile devices includes: one or more data processors and a machine readable storage medium. The storage medium is encoded with instructions for commanding the data processors to execute certain operations. A connection between a mobile device and an anti-loss device is established. A distance between the mobile device and the anti-loss device is detected based at least in part on the connection. In response to the distance between the mobile device and the anti-loss device being larger than a threshold, whether the mobile device is lost is determined based at least in part on a user input. In response to the user input not satisfying one or more conditions, an anti-loss mode is triggered. An alarm is provided upon the triggering of the anti-loss mode.

### BRIEF DESCRIPTION OF THE DRAWINGS

FIG. 1 depicts an example diagram showing an anti-loss device for a mobile device.

FIG. 2 depicts an example diagram showing an anti-loss system for a mobile device.

FIG. 3 depicts an example diagram showing multiple anti-loss devices implemented for one or more mobile devices.

FIG. 4 depicts an example flow chart showing an anti-loss mechanism for mobile devices.

FIG. 5 depicts an example diagram showing an anti-loss mechanism for mobile devices.

### DETAILED DESCRIPTION

Some anti-loss mechanisms have been adopted for mobile devices. For example, Global Positioning System (GPS) services can be used to locate a mobile device after it is lost. However, GPS positioning alone is often not sufficient.

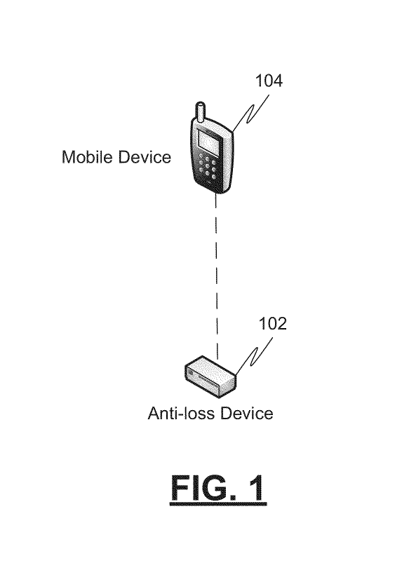

FIG. 1 depicts an example diagram showing an anti-loss device for a mobile device. As shown in FIG. 1, a distance between the anti-loss device 102 and the mobile device 104 is monitored (e.g., by certain modules within the mobile device 104). If the mobile device 104 is moved far away from the anti-loss device 102, user inputs (e.g., a password, facial recognition, etc.) are received for determining whether the mobile device 104 is lost. If the user inputs do not satisfy certain predetermined conditions, it indicates that the mobile device 104 is lost. An alarm is generated at the mobile device 104, and a protection mechanism can be activated to protect the mobile device 104 (e.g., locking the mobile device 104). For example, the mobile device 104 is a smart phone, a tablet computer, etc. The anti-loss device 102 is included in a Near Field Communication (NFC) card, a key chain, a belt buckle Bluetooth earphone, a jewelry box, etc.

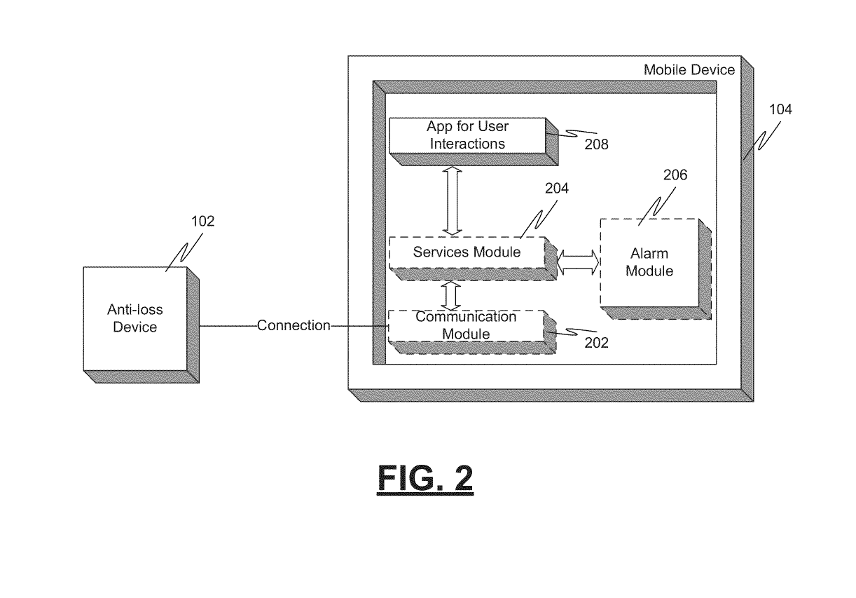

FIG. 2 depicts an example diagram showing an anti-loss system for a mobile device. As shown in FIG. 2, a communication module 202 establishes a connection between the mobile device 104 and the anti-loss device 102. A services module 204 detects the distance between the mobile device 104 and the anti-loss device 102. If the distance between the mobile device 104 and the anti-loss device 102 is larger than a threshold, the services module 204 determines if the mobile device is lost upon certain user inputs. If the user inputs do not satisfy predetermined conditions, an anti-loss mode is triggered. An alarm module 206 generates an alarm upon the triggering of the anti-loss mode.

Specifically, the communication module 202 can establish the connection between the mobile device 104 and the anti-loss device 102 via various technologies, such as Bluetooth, NFC, WiFi, a physical communication line, etc. Once the connection is established, the anti-loss device 102 communicates with the mobile device 104, e.g., intermittently. The communication module 202 detects the distance between the anti-loss device 102 and the mobile device 104 at predetermined time intervals. Once the mobile device 104 is moved far away from the anti-loss device 104, the services module 204 may prompt user inputs through application software 208. The owner of the mobile device 104 can predefine certain conditions for anti-loss purposes, such as a password, a pattern, facial recognition, etc. If the user inputs received by the services module 204 do not match with the predetermined conditions, it indicates that the current user of the mobile device 104 is not the owner of the mobile device 104, and the mobile device 104 is lost (e.g., stolen). For example, the user inputs may be received through a touch screen, a keyboard, a microphone, a camera, etc.

In some embodiments, the alarm module 206 may generate a loud sound upon the triggering of the anti-loss mode. The alarm module 206 may activate a camera of the mobile device 104 to take one or more photos of the current user or activate a recording device to record a sound of the current user, so that the photos or the sound recording may be used as evidence against the current user. In addition, the alarm module 206 may activate positioning determination services so that the owner may locate the mobile device 104 via Global Positioning System (GPS) signals. Furthermore, the alarm module 206 may cause an automatic phone call to be made to a particular number predetermined by the owner of the mobile device 104.

In some embodiments, the communication module 202, the services module 204, and/or the alarm module 206 are included in the mobile device 104. In certain embodiments, the communication module 202, the services module 204, and/or the alarm module 206 are located on a system (e.g., a server) that communicates with the mobile device 104.

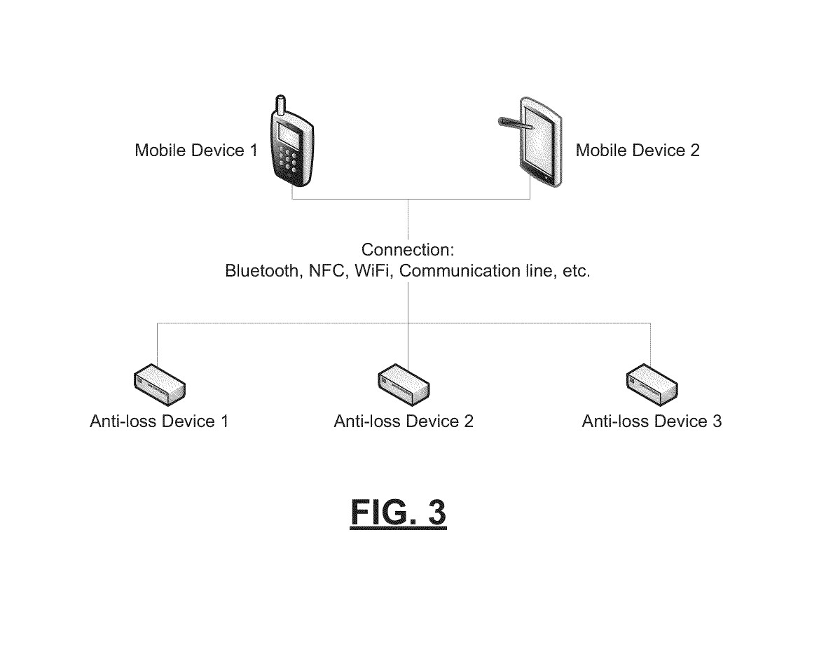

In certain embodiments, the anti-loss device 102 includes batteries to provide power for communication with the mobile device 104, e.g., via Bluetooth. In some embodiments, the anti-loss device 102 does not include batteries, and communicates with the mobile device 104 via NFC. Multiple anti-loss devices may be implemented for one or more mobile devices, as shown in FIG. 3.

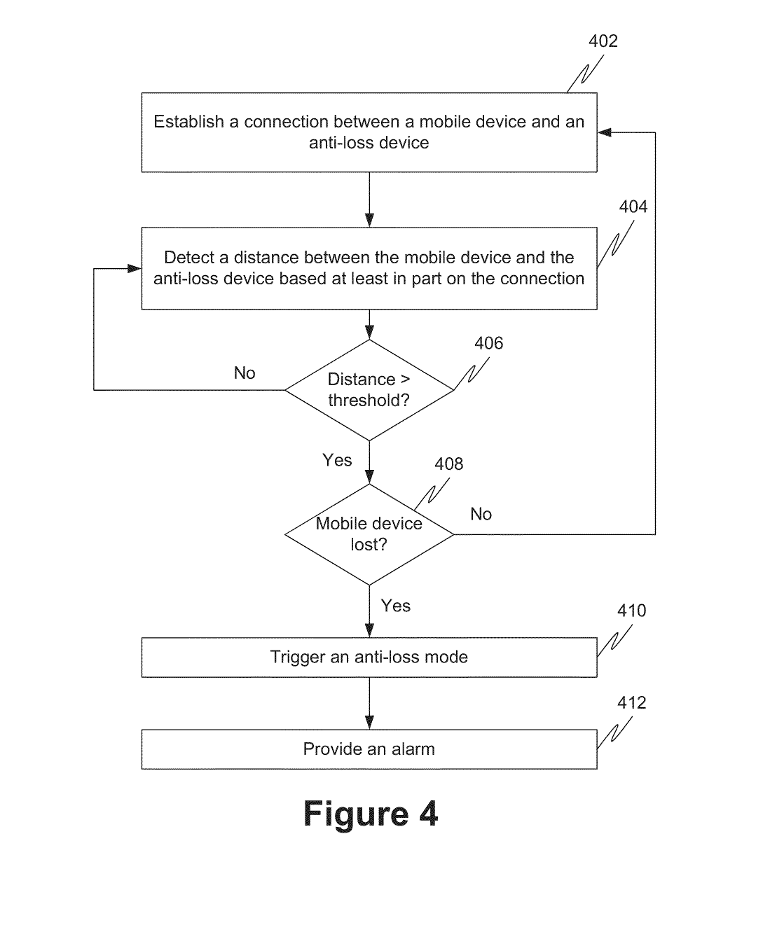

FIG. 4 depicts an example flow chart showing an anti-loss mechanism for mobile devices. At 402, a connection between a mobile device and an anti-loss device is established. At 404, a distance between the mobile device and the anti-loss device is detected based at least in part on the connection. At 406, it is determined if the distance between the mobile device and the anti-loss device is larger than a threshold. If the distance between the mobile device and the anti-loss device is not larger than the threshold, it indicates that the mobile device is not moved far away from the anti-loss device and thus is not lost. The detection of the distance continues. On the other hand, if the distance between the mobile device and the anti-loss device is larger than the threshold, it indicates that the mobile device is moved far away from the anti-loss device.

At 408, it is determined whether the mobile device is lost based at least in part on a user input. If the user input satisfies one or more conditions (e.g., predetermined by an owner of the mobile device), it indicates that the user is the owner of the mobile device, and the mobile device is not lost. Thus, the mobile device may be set to a waiting mode. In some embodiments, the connection between the mobile device and the anti-loss device may be reestablished (e.g., after a time period). If the user input does not satisfy the predetermined conditions, it indicates that the user is not the owner of the mobile device, and the mobile device may be lost. At 410, an anti-loss mode is triggered. At 412, an alarm (e.g., a loud sound) is provided upon the triggering of the anti-loss mode.

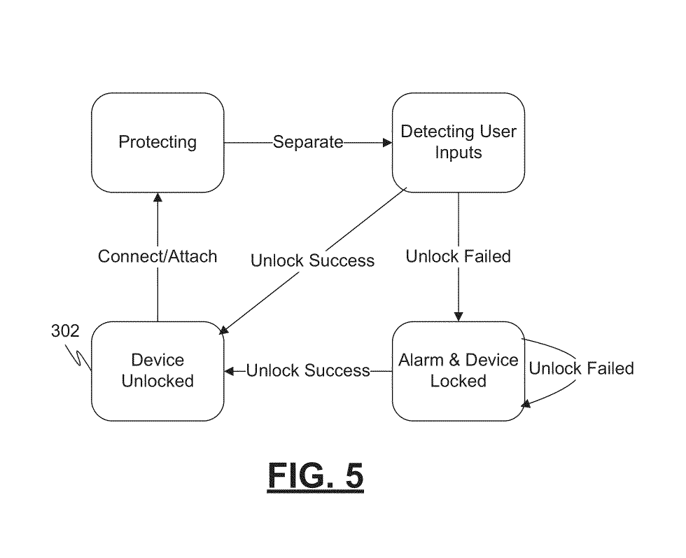

FIG. 5 depicts an example diagram showing an anti-loss mechanism for mobile devices. As shown in FIG. 5, a mobile device 302 is initially unlocked, and is then connected (or attached) with an anti-loss device. If the mobile phone 302 is moved far away from the anti-loss device, user inputs are detected. If the user inputs satisfy certain predetermined unlock conditions, it indicates that the mobile phone 302 is not lost. The mobile device 302 remains unlocked.

On the other hand, if the user inputs do not satisfy the predetermined unlock conditions, an alarm (e.g., a loud sound) is generated and the mobile device 302 is automatically locked. In some embodiments, the detection of the user inputs may continue. If the subsequent user inputs satisfy the unlock conditions, the mobile device 302 is unlocked. Otherwise, the alarm may be again generated, and the mobile device 302 remains locked.

This written description uses examples to disclose the invention, include the best mode, and also to enable a person skilled in the art to make and use the invention. The patentable scope of the invention may include other examples that occur to those skilled in the art. Other implementations may also be used, however, such as firmware or appropriately designed hardware configured to carry out the methods and systems described herein. For example, the systems and methods described herein may be implemented in an independent processing engine, as a co-processor, or as a hardware accelerator. In yet another example, the systems and methods described herein may be provided on many different types of computer-readable media including computer storage mechanisms (e.g., CD-ROM, diskette, RAM, flash memory, computer's hard drive, etc.) that contain instructions (e.g., software) for use in execution by one or more processors to perform the methods' operations and implement the systems described herein.

What is claimed is:

1. An anti-loss system for a mobile device, the system comprising:
a communication module configured to establish a connection between a mobile device and an anti-loss device;
a services module configured to:
detect a distance between the mobile device and the anti-loss device based at least in part on the connection;
in response to the distance between the mobile device and the anti-loss device being larger than a threshold, determine whether the mobile device is lost based at least in part on a user input; and
in response to the user input not satisfying one or more conditions, trigger an anti-loss mode; and
an alarm module configured to provide an alarm upon the triggering of the anti-loss mode.

2. The system of claim 1, wherein the conditions include one or more of: a password, a pattern, and facial recognition.

3. The system of claim 1, wherein the conditions are predefined by a user.

4. The system of claim 1, wherein the communication module is further configured to establish the connection via Bluetooth, Near Field Communication, WiFi, or a physical communication line.

5. The system of claim 1, wherein the communication module is further configured to establish the connection for the anti-loss device to communicate with the mobile device intermittently.

6. The system of claim 1, wherein one or more of the communication module, the services module and the alarm module are included in the mobile device.

7. The system of claim 1, wherein the alarm module is further configured to generate a sound.

8. The system of claim 1, wherein the alarm module is further configured to, in response to the triggering of the anti-loss mode, cause one or more photos of a current user to be taken, cause a sound to be recorded, determine a position via Global Positioning System (GPS) signals, or cause an automatic phone call.

9. The system of claim 1, wherein the services module is configured to receive the user input through a touch screen, a keyboard, a microphone or a camera.

10. An anti-loss method for a mobile device, the method comprising:
establishing a connection between a mobile device and an anti-loss device;
detecting a distance between the mobile device and the anti-loss device based at least in part on the connection;
in response to the distance between the mobile device and the anti-loss device being larger than a threshold, determining whether the mobile device is lost based at least in part on a user input;
in response to the user input not satisfying one or more conditions, triggering an anti-loss mode; and
providing an alarm upon the triggering of the anti-loss mode.

11. The method of claim 10, wherein the conditions include one or more of: a password, a pattern, and facial recognition.

12. The method of claim 10, wherein the conditions are predefined through user operations.

13. The method of claim 10, wherein the connection is established via Bluetooth, Near Field Communication, WiFi, or a physical communication line.

14. The method of claim 10, wherein the connection is established for the anti-loss device to communicate with the mobile device intermittently.

15. The method of claim 10, wherein the distance is determined at one or more predetermined time intervals.

16. The method of claim 10, wherein the alarm includes a sound.

17. The method of claim 10, wherein the user input is received through a touch screen, a microphone or a camera.

18. An anti-loss system for a mobile device, the system comprising:
one or more data processors; and
a machine readable storage medium encoded with instructions for commanding the data processors to execute operations including:
establishing a connection between a mobile device and an anti-loss device;
detecting a distance between the mobile device and the anti-loss device based at least in part on the connection;
in response to the distance between the mobile device and the anti-loss device being larger than a threshold, determining whether the mobile device is lost based at least in part on a user input;
in response to the user input not satisfying one or more conditions, triggering an anti-loss mode; and
providing an alarm upon the triggering of the anti-loss mode.

19. The system of claim 18, wherein the instructions are adapted to command the data processors to establish the connection based at least in part on communications between the anti-loss device and the mobile device, the anti-loss device communicating with the mobile device intermittently.

20. The system of claim 18, wherein the conditions include one or more of: a password, a pattern, and facial recognition.
